(19) United States
(12) Patent Application Publication
(10) Pub. No.: US 2021/0333596 A1
(43) Pub. Date: Oct. 28, 2021

(54) METHOD FOR SELECTING SPACER USED IN LIQUID CRYSTAL PANEL, AND LIQUID CRYSTAL PANEL

(71) Applicant: HUIZHOU CHINA STAR OPTOELECTRONICS TECHNOLOGY CO., LTD., Huizhou (CN)

(72) Inventor: Qianshuang HU, Huizhou (CN)

(73) Assignee: HUIZHOU CHINA STAR OPTOELECTRONICS TECHNOLOGY CO., LTD., Huizhou (CN)

(21) Appl. No.: 16/618,408

(22) PCT Filed: Nov. 8, 2019
(86) PCT No.: PCT/CN2019/116638

§ 371 Date: Dec. 2, 2019

(30) Foreign Application Priority Data
Jul. 26, 2019 (CN) 201910681655.2

(51) Int. Cl. G02F 1/1339

(52) U.S. Cl. CPC G02F 1/13394; G02F 1/13398

(57) ABSTRACT

The present application provides a method for selecting a spacer used in a liquid crystal panel, including: preparing a plurality of samples, wherein each of the samples is disposed on a surface of a glass substrate; sequentially applying different preset pressures to the plurality of samples, and outputting compression amounts of spacers in the samples corresponding to the preset pressures; and calculating heights of the spacers after compression based on the compression amounts of the spacers, and comparing the heights with a standard distance between an upper substrate and a lower substrate of the liquid crystal panel, and picking out the sample that meets a design specification of the liquid crystal panel.

### FIELD OF INVENTION

The present application relates to the field of display technology, and in particular, to a method for selecting a spacer used in a liquid crystal panel, and a liquid crystal panel.

### BACKGROUND OF INVENTION

As the market demand for liquid crystal panels continually increases, the liquid crystal panels are often produced in one place and then shipped to another place for use. Due to differences in climates and altitudes in different regions, pressures that the liquid crystal panels are subjected to are different; consequently, liquid crystals and spacers inside the liquid crystal panels are prone to deformation, which raises high demands on design and manufacturing.

As temperature drops, liquid crystals shrink in the liquid crystal panel, spacers are compressed, and the space inside a cell is reduced. When the spacer cannot continue to be compressed, the space inside the cell is no longer reduced. If a volume of the space inside the cell is greater than a volume of the liquid crystals, the liquid crystals will peel off from a surface of a glass substrate to form a vacuum bubble, which affects normal display of the liquid crystal panel.

### Technical Problem

An objective of the present application is to provide a method for selecting a spacer used in a liquid crystal panel, and a liquid crystal panel, which solve the technical problem as follows: when the liquid crystal panel is under pressure, spacers therein are compressed in the liquid crystal panel, liquid crystals shrink, and a volume of an inner space of a cell is greater than a volume of the liquid crystals; thereby, the liquid crystals are peeled off from a surface of the glass substrate to form a vacuum bubble, which consequently reduces yield of the liquid crystal panel.

### SUMMARY OF INVENTION

In order to solve the above problem, an embodiment of the present application provides a method for selecting a spacer used in a liquid crystal panel, and the method is as follows:

Step 1, preparing a plurality of samples, wherein each of the samples comprises a glass substrate and a plurality of spacers fixed on the glass substrate, and an initial volume ratio of each spacer to a space above the glass substrate is same;

Step 2, sequentially applying different preset pressures to the plurality of samples, and outputting amounts of compression of the spacers in the samples corresponding to the preset pressures; and

Step 3, calculating heights of the spacers after compression based on the amounts of compression of the spacers, and comparing the heights with a standard distance between an upper substrate and a lower substrate of the liquid crystal panel, and picking out the sample that meets a design specification of the liquid crystal panel.

Wherein step 1 of preparing the plurality of samples specifically includes:

in any one of the samples, which has a same initial height of the spacers, determining number of spacers of the samples based on a radius of the spacers of the samples; and disposing an array of the spacers of the sample on the glass substrate of the sample based on the number of spacers of the samples.

Wherein step 1 of preparing the plurality of samples specifically includes:

in any one of the samples, which has a same initial radius of the spacers, determining number of spacers of the samples based on heights of the spacers of the samples; and disposing an array of the spacers of the samples on the glass substrate of the samples based on the numbers of spacers of the samples.

Wherein step 1 of preparing the plurality of samples specifically includes:

in any one of the samples, which has a same initial number of the spacers, determining a radius of the spacers of the samples based on heights of the spacers of the samples; and disposing an array of the spacers of the samples on the glass substrate of the samples based on the radius of the spacers of the samples.

Wherein step 2 of sequentially applying different preset pressures to the plurality of samples, and outputting compression amounts of the spacers in the samples corresponding to the preset pressures specifically includes:

attaching the glass substrate of any one of the samples to a press table, downwardly moving an indenter of the press table and attaching the indenter to a surface of the spacer, and applying different preset pressures to the indenter.

Wherein step 2 of sequentially applying different preset pressures to the plurality of samples, and outputting compression amounts of the spacers in the samples corresponding to the preset pressures specifically includes:

in any two or more of the samples, which have a same initial height and a same compression amount of the spacers, increasing the preset pressure when a radius of the spacer is larger;

in each of the samples, which has the same initial height, applying the same preset pressure, and picking out the compression amount in each of the samples as the compression amount of the spacers in the samples; and

in each of the samples, which has different initial heights of the spacers, applying the same preset pressure, and picking out the compression amount of the spacers which has the largest initial height in each of the samples as the compression amount of the spacers in the samples.

Wherein step 3 of calculating heights of the spacers after compression based on the compression amounts of the spacers, and comparing the heights with a standard distance between an upper substrate and a lower substrate of the liquid crystal panel, and picking out the sample that meets a design specification of the liquid crystal panel specifically includes:

subtracting a compression amount of the spacer from the initial height of the spacer to obtain a height of the spacer after compression.

Wherein step 3 of calculating heights of the spacers after compression based on the compression amounts of the spacers, and comparing the heights with a standard distance between an upper substrate and a lower substrate of the liquid crystal panel, and picking out the sample that meets a design specification of the liquid crystal panel specifically includes:

applying a preset pressure equivalent to a pressure that the spacers in the liquid crystal panel are subjected to in the corresponding regions; picking out each compression amount of the spacers in each of the samples under the preset pressure, and calculating heights after compression of the spacers in the plurality of samples;

sequentially comparing the heights of the spacers each in the plurality of samples to the standard distance between the upper substrate and lower substrate of the liquid crystal panel in the corresponding region; and picking out a sample that meets the design specification of the liquid crystal panel in the corresponding region, and taking a spacer of the samples as a preferred solution.

In order to solve the above problems, an embodiment of the present application further provides a liquid crystal panel, including a spacer selected by the method. The liquid crystal panel further includes an upper substrate and a lower substrate disposed opposite to each other, and a liquid crystal cell between the upper substrate and the lower substrate. The spacer is positioned on a surface of the lower substrate and extends to the upper substrate for supporting a thickness of the cell.

### BENEFICIAL EFFECT

The beneficial effects of the application are achieved by:

preparing a plurality of samples, wherein spacers in each of the samples are disposed on a surface of the glass substrate; sequentially applying different preset pressures to the plurality of samples, and outputting compression amounts of the spacers in the samples corresponding to the preset pressures; and calculating heights of the spacers after compression based on the compression amounts of the spacers, and comparing the heights with a standard distance between an upper substrate and a lower substrate of the liquid crystal panel to pick out the sample that meets a design specification of the liquid crystal panel. This ensures that a volume ratio of the liquid crystals to the spacers is uniform under different pressures, a space inside the liquid crystal cell is filled, and the liquid crystal does not peel off from a surface of the glass substrate, consequently preventing formation of vacuum bubbles, thereby improving the yield of the liquid crystal panel.

### DESCRIPTION OF DRAWINGS

In order to more clearly illustrate the technical solutions in the embodiments of the present invention, the following figures described in the embodiments will be briefly introduced. It is obvious that the drawings described below are merely some embodiments of the present invention, and other drawings can also be obtained by a person of ordinary skill in the field based on these drawings without any creative effort.

FIG. 1 is a schematic flow chart of a method for selecting a spacer used in a liquid crystal panel according to an embodiment of the present application.

FIG. 2 is a schematic structural diagram of a sample according to an embodiment of the present application.

FIG. 3 is a schematic structural diagram of a spacer according to an embodiment of the present application.

FIG. 4 is a schematic diagram of a sample under compression according to an embodiment of the present application.

FIG. 5 is a schematic diagram showing a relationship between a compression amount of a spacer and a preset pressure according to an embodiment of the present application.

### DETAILED DESCRIPTION OF PREFERRED EMBODIMENTS

The present application will be further described in detail with reference to the accompanying drawings and embodiments. It is noted that the following embodiments are merely illustrative of the present application, but are not intended to limit the scope of the application. In addition, the following embodiments are only partial embodiments of the present application and not all of the embodiments. All other embodiments obtained by those skilled in the art without creative efforts are within the scope of the present application.

The application is directed to the technical problem of prior art: when a liquid crystal panel is under pressure, spacers therein are compressed in the liquid crystal panel, liquid crystals shrink, and a volume of an inner space of a cell is greater than a volume of the liquid crystals; thereby, the liquid crystals are peeled off from a surface of the glass substrate to form a vacuum bubble, which consequently reduces yield of the liquid crystal panel. This embodiment can solve the problem.

Conventional liquid crystal panels use double spacers, and the double spacers include a main spacer and an auxiliary spacer, wherein the main spacer is higher, the distribution thereof is less, and it plays a major supporting role for the liquid crystal cell; the auxiliary spacer is shorter and the distribution thereof is denser, and it is used to increase a pressure resistance of the panel, so a height of the auxiliary spacer changes. A distance between upper and lower substrates of the liquid crystal panel changes accordingly, and a height between the upper and lower substrates of the liquid crystal panel can be measured by a height of the spacer. When space inside the cell of liquid crystal panel is reduced, the spacer cannot continue to be compressed, and a volume of the space inside the cell is greater than that of the liquid crystals; consequently, a vacuum bubble is generated. Therefore, by changing numbers of spacers to enhance or reduce compression performance of overall spacers, the problem of vacuum bubbles in the liquid crystal panel can be improved.

This application simplifies a spacer test model, by applying a preset pressure to the substrates on both sides of the spacer, outputting a compression amount of the spacer, calculating the height of the spacer after compression based on the compression amount, and comparing the height with a standard distance between the upper and lower substrates in the liquid crystal panel at different pressures. If the height is within the standard distance, it is preferably selected as a spacer design solution of the compression amount at the corresponding pressure.

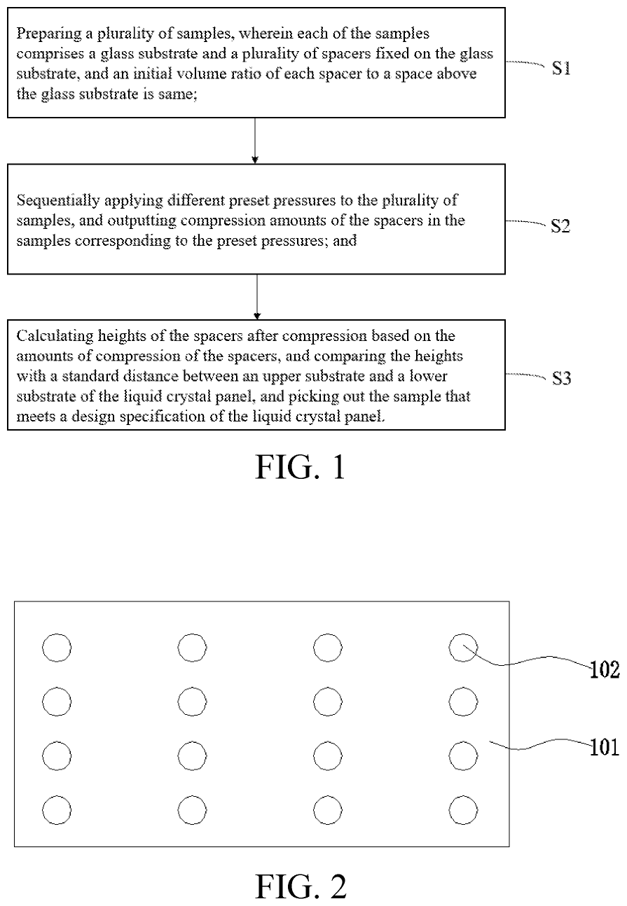

The present application provides a method for selecting a spacer used in a liquid crystal panel. As shown in FIG. 1, for selecting a reasonable spacer design to reduce the vacuum bubble rate in the liquid crystal panel, the method includes the following steps:

Step 1, preparing a plurality of samples, wherein each of the samples comprises a glass substrate and a plurality of spacers fixed on the glass substrate, and an initial volume ratio of each spacer to a space above the glass substrate is same;

Step 2, sequentially applying different preset pressures to the plurality of samples, and outputting amounts of compression of the spacers in the samples corresponding to the preset pressures; and

Step 3, calculating heights of the spacers after compression based on the amounts of compression of the spacers, and comparing the heights with a standard distance between an upper substrate and a lower substrate of the liquid crystal panel, and picking out the sample that meets a design specification of the liquid crystal panel.

Preferably, step 1 of preparing the plurality of samples specifically includes:

in any one of the samples, which has a same initial height of the spacers, determining a number of spacers of the sample based on a radius of the spacers of the sample; and disposing an array of the spacers of the sample on the glass substrate of the sample based on the number of spacers of the sample.

Preferably, step 1 of preparing the plurality of samples specifically includes:

in any one of the samples, which has a same initial radius of the spacers, determining the number of spacers of the sample based on heights of the spacers of the sample; and disposing the array of the spacers of the sample on the glass substrate of the sample based on the number of spacers of the sample.

Preferably, step 1 of preparing the plurality of samples specifically includes:

in any one of the samples, which has a same initial number of the spacers, determining the radius of the spacers of the sample based on heights of the spacers of the sample; and disposing the array of the spacers of the sample on the glass substrate of the sample based on the radius of the spacers of the sample.

Preferably, step 2 of sequentially applying different preset pressures to the plurality of samples, and outputting compression amounts of the spacers in the samples corresponding to the preset pressures specifically includes:

attaching the glass substrate of any one of the samples to a press table, downwardly moving an indenter of the press table and attaching the indenter to a surface of the spacer, and applying different preset pressures to the indenter.

Preferably, step 2 of sequentially applying different preset pressures to the plurality of samples, and outputting compression amounts of the spacers in the samples corresponding to the preset pressures specifically includes:

in any two or more of the samples, which have a same initial height and a same compression amount of the spacers, increasing the preset pressure when the radius of the spacers is larger.

Preferably, step 2 of sequentially applying different preset pressures to the plurality of samples, and outputting compression amounts of the spacers in the samples corresponding to the preset pressures specifically includes:

in each of the samples, which has the same initial height, applying the same preset pressure, and picking out the compression amount in each of the samples as the compression amount of the spacers in the samples; and

in each of the samples, which has different initial heights of the spacers, applying the same preset pressure, and picking out the compression amount of the spacers which has the largest initial height in each of the samples as the compression amount of the spacers in the samples.

Preferably, step 3 of calculating the heights of the spacers after compression based on the compression amounts of the spacers, and comparing the heights with the standard distance between the upper substrate and the lower substrate of the liquid crystal panel, and picking out the sample that meets the design specification of the liquid crystal panel specifically includes:

subtracting the compression amount of the spacers from the initial heights of the spacers to obtain the heights of the spacers after compression.

Preferably, step 3 of calculating the heights of the spacers after compression based on the compression amount of the spacers, and comparing the heights with the standard distance between the upper substrate and the lower substrate of the liquid crystal panel, and picking out the sample that meets the design specification of the liquid crystal panel specifically includes:

applying the preset pressure equivalent to a pressure that the spacers in the liquid crystal panel are subjected to in the corresponding regions;

picking out each compression amount of the spacers in each of the samples under the preset pressure, and calculating the heights after compression of the spacers in the plurality of samples;

sequentially comparing the heights of the spacers in the plurality of samples to the standard distance between the upper substrate and lower substrate of the liquid crystal panel in the corresponding region; and picking out the sample that meets the design specification of the liquid crystal panel in the corresponding region, and taking the spacer of the sample as a preferred solution.

As shown in FIG. 2, a spacer 102 of the present embodiment is made of an elastic material and is fixed to a glass substrate 101. The spacer 102 is elastically contracted and deformed after being compressed. A shape of the spacer 102 is preferably a boss or a cylinder, and a bottom angle of the spacer 102 is preferably 0° to 180°. An array of the spacers 102 is distributed on the glass substrate 101. The larger a radius of the spacers 102 is, the smaller the number of the spacers 102, and the larger the preset pressure is applied to the spacers 102, the larger the compression amount of the spacers 102.

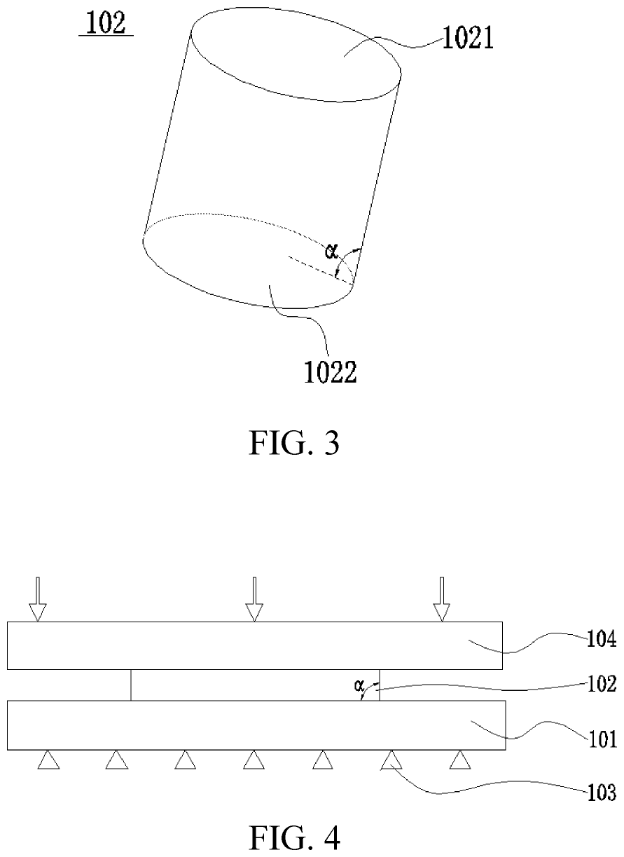

As shown in FIG. 3, the spacer 102 of the embodiment is a cylinder. A top surface 1021 is parallel to a bottom surface 1022, the top surface 1021 and the bottom surface 1022 have an identical surface area, and the bottom angle α is 90°. According to actual needs, the spacer 102 can also be a boss, the surface areas of the top surface 1021 and the bottom surface 1022 can be unequal, and the bottom angle α is greater than 0° and less than 180°.

Applicant adopts a control variable method to design five groups of samples. Volume ratios of the spacers above the substrate are identical in each of the samples. The initial height of the spacer H is 3 μm and the bottom angle is 90°, that is, the spacer is a cylinder. In the first group of the samples, the spacer has a radius of 50 μm, and the number is 1. In the second group of the samples, the spacer radius is 35.35534 μm, and the number is 2. In the third group of the samples, the spacer radius is 25 μm, and the number is 4. In the fourth group of the samples, the spacer radius is 17.67767 μm, and the number is 8. In the fifth group of the samples, the spacer radius is 12.5 μm, and the number is 16. As shown in Table 1, under a pressure of 200 μN, the compression amount of the spacer and the compression ratio in each sample were obtained.

TABLE 1
5 groups of samples

| spacer | 1 | 2 | 3 | 4 | 5 |
|---|---|---|---|---|---|
| bottom angle | 90° | | | | |
| height (μm) | 3 | | | | |
| radius (μm) | 50 | 35.35534 | 25 | 17.67767 | 12.5 |
| number of | 1 | 2 | 4 | 8 | 16 |
| samples | | | | | |
| pressure (μN) | 200 | | | | |
| compression | 0.0094 | 0.0157 | 0.0259 | 0.0413 | 0.0621 |
| amount (μm) | | | | | |
| compression | 0.31 | 0.52 | 0.86 | 1.38 | 2.07 |
| ratio (%) | | | | | |

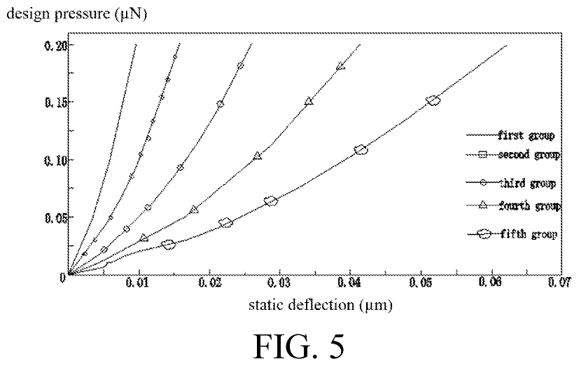

Shown in FIG. 4 is a spacer sample compression diagram of the present application. A glass substrate 101 is attached to a press 103, an indenter 104 of the press moves downward, and is attached to a top surface of the spacer 102. A preset pressure is applied to the indenter 104, a compression amount of the spacer 102 corresponding to the pressure is outputted, and a corresponding compression ratio based on the compression amount is calculated. By applying different preset pressures to each of the samples, the compression amount of the spacers in each of the samples is correspondingly outputted. In FIG. 5, the compression amount is the abscissa, and the preset pressure is the ordinate.

As shown in FIG. 5, the compression amount of the spacer has a linear relationship with the preset pressure. The greater the preset pressure applied to the sample, the greater the compression amount of the spacers in the sample. Applying the same preset pressure, the compression amounts of the spacers in the first group of samples, the second group of samples, the third group of samples, the fourth group of samples, and the fifth group of samples are sequentially increased. In a case that the compression amounts of the spacers are the same, the preset pressures that can be subjected to the first group of samples, the second group of samples, the third group of samples, the fourth group of samples, and the fifth group of samples are sequentially reduced.

According to the above objective of the present application, a liquid crystal panel is provided, including a spacer selected by a method for selecting the spacer used in a liquid crystal panel of the embodiment. The liquid crystal panel includes an upper substrate and a lower substrate disposed opposite to each other, and a liquid crystal cell between the upper substrate and the lower substrate. The spacer is positioned on a surface of the lower substrate and extends to the upper substrate for supporting a thickness of the cell.

By a plot with a relationship between a compression amount of the spacer and a preset pressure, the compression amount of the spacer under different preset pressures can be quickly found, and a height of the spacer after compression can be quickly calculated, and then compared with a database having a standard distance between the upper and lower substrates of the liquid crystal panel in a corresponding region to find a reasonable spacer design.

The description of the above exemplary embodiments is only for the purpose of understanding the invention. It is to be understood that the present invention is not limited to the disclosed exemplary embodiments. It is obvious to those skilled in the art that the above exemplary embodiments may be modified without departing from the scope and spirit of the present invention.

What is claimed is:

1. A method for selecting a spacer used in a liquid crystal panel, wherein the method comprises following steps:
step 1, preparing a plurality of samples, wherein each of the samples comprises a glass substrate and a plurality of spacers fixed on the glass substrate, and an initial volume ratio of each spacer to a space above the glass substrate is same;
step 2, sequentially applying different preset pressures to the plurality of samples, and outputting amounts of compression of the spacers in the samples corresponding to the preset pressures; and
step 3, calculating heights of the spacers after compression based on the amounts of compression of the spacers, and comparing the heights with a standard distance between an upper substrate and a lower substrate of the liquid crystal panel, and picking out the sample that meets a design specification of the liquid crystal panel.

2. The method for selecting the spacer used in the liquid crystal panel of claim 1, wherein the step 1 of preparing the plurality of samples specifically comprises:
in any one of the samples, which has a same initial height of the spacers, determining a number of spacers of the sample based on a radius of the spacers of the sample; and
disposing an array of the spacers of the sample on the glass substrate of the sample based on the number of spacers of the sample.

3. The method for selecting the spacer used in the liquid crystal panel of claim 1, wherein the step 1 of preparing the plurality of samples specifically comprises:
in any one of the samples, which has a same initial radius of the spacers, determining a number of spacers of the sample based on heights of the spacers of the sample; and
disposing an array of the spacers of the sample on the glass substrate of the sample based on the numbers of spacers of the sample.

4. The method for selecting the spacer used in the liquid crystal panel of claim 1, wherein the step 1 of preparing the plurality of samples specifically comprises:
in any one of the samples, which has a same initial number of the spacers, determining a radius of the spacers of the sample based on heights of the spacers of the sample; and
disposing an array of the spacers of the sample on the glass substrate of the sample based on the radius of the spacers of the sample.

5. The method for selecting the spacer used in the liquid crystal panel of claim 1, wherein the step 2 of sequentially applying different preset pressures to the plurality of samples, and outputting the amounts of compression of the spacers in the samples corresponding to the preset pressures specifically comprises:
attaching the glass substrate of any one of the samples to a press table, downwardly moving an indenter of the press table and attaching the indenter to a surface of the spacer, and applying different preset pressures to the indenter.

6. The method for selecting the spacer used in the liquid crystal panel of claim 1, wherein the step 2 of sequentially applying different preset pressures to the plurality of samples, and outputting the amounts of compression of the spacers in the samples corresponding to the preset pressures specifically comprises:
in any two or more of the samples, which have a same initial height and a same compression amount of the spacers, increasing the preset pressure when a radius of the spacer is larger.

7. The method for selecting the spacer used in the liquid crystal panel of claim 1, wherein the step 2 of sequentially applying different preset pressures to the plurality of samples, and outputting the amounts of compression of the spacers in the samples corresponding to the preset pressures specifically comprises:
in each of the samples, which has a same initial height, applying a same preset pressure, and picking out the compression amount in each of the samples as the compression amount of the spacers in the samples; and
in each of the samples, which has different initial heights of the spacers, applying the same preset pressure, and picking out the compression amount of the spacer which has the largest initial height in each of the samples as the compression amount of the spacers in the samples.

8. The method for selecting the spacer used in the liquid crystal panel of claim 1, wherein the step 3 of calculating the heights of the spacers after compression based on the amounts of compression of the spacers, and comparing the heights with the standard distance between the upper substrate and the lower substrate of the liquid crystal panel, and picking out the sample that meets the design specification of the liquid crystal panel specifically comprises:
subtracting the compression amount of the spacer from an initial height of the spacer to obtain the height of the spacer after compression.

9. The method for selecting the spacer used in the liquid crystal panel of claim 1, wherein the step 3 of calculating the heights of the spacers after compression based on the compression amount of the spacers, and comparing the heights with the standard distance between the upper substrate and the lower substrate of the liquid crystal panel, and picking out the sample that meets the design specification of the liquid crystal panel specifically comprises:
applying the preset pressure equivalent to a pressure that the spacers in the liquid crystal panel are subjected to in the corresponding regions;
picking out the compression amount of the spacers in each of the samples under the preset pressure, and calculating the heights of the spacers after compression in the plurality of samples;
sequentially comparing the heights of the spacers in the plurality of samples to the standard distance between the upper substrate and the lower substrate of the liquid crystal panel in the corresponding region; and
picking out the sample that meets the design specification of the liquid crystal panel in the corresponding region, and taking the spacer of the sample as a preferred solution.

10. A liquid crystal panel, comprising a spacer selected by the method for selecting the spacer of claim 1.
